(19) United States
(12) Patent Application Publication
(10) Pub. No.: US 2012/0246372 A1
(43) Pub. Date: Sep. 27, 2012

(54) PCI-E BUS ACHIEVED CONNECTOR EXPANSION MODULE

(76) Inventor: Nai-Chien CHANG, New Taipei City (TW)

(21) Appl. No.: 13/399,629

(22) Filed: Feb. 17, 2012

(30) Foreign Application Priority Data
Mar. 22, 2011 (TW) 100205107

(51) Int. Cl. G06F 13/00

(52) U.S. Cl. 710/301

(57) ABSTRACT

A PCI-E bus achieved connector expansion module includes a connection joint, a plurality of transmission wires, and at least one connector. Shape and size of the connection joint is corresponding to that of PCI-E bus slot, so the connection joint can insert into the PCI-E bus slot for electrically connecting with pins in the PCI-E bus which the expansion module connects with. One end of each transmission wires electrically connects to the connection joint separately, and the other end of each transmission wires connects to the connector separately. Therefore, the expansion module can be used to expand at least one connector for an electronic device via PCI-E interface thereon.

### BACKGROUND OF THE INVENTION

1. Field of the invention

The invention related to an expansion module, and in particular to an expansion module which can expand connectors for a motherboard via PCI-E interface on the motherboard.

2. Description of Prior Art

Since the development of the computer, because of the great power of the computer, it is being more and more important in day life. Further, following the development of semiconductor industry, the price of the computer becomes lower and lower, and the lower price causes the popularization of the computer around people.

The computer communicates with external device through different connectors thereon, for example, universal serial bus (USB) connector, external serial advanced technology attachment (eSATA) connector, fire wire (so called IEEE 1394), headphone output port, microphone input port, and so on. The above connectors provide the convenience for communicating externally, but they also occupy a great portion of arrangement space on a motherboard of the computer.

Generally, the amount and the species of the connectors set on the motherboard are limited because the limitation of the arrangement space of the motherboard. Furthermore, the connectors usually set on rear end of the computer due to the location of the motherboard. However, the location of the connectors causes the inconvenience of inserting in or pulling out external devices, such as USB flash drive, eSATA hard drive, headphone, or microphone, from the connectors.

For resolving the problem mentioned above, a computer expansion module (as referred to as computer front line) is provided in the market. FIG. 1 is a connection view of a prior art front line. The front lint 1 mainly has a connection slot 11, a cable 12 and a plurality of connectors 13, wherein, the cable 12 electrically connects to the connection slot 11 and the plurality of connectors 13.

A motherboard 2 of the computer mainly has a plurality of connection pins 21 and at least one control integrated circuit (IC) 22 which electrically connects to the plurality of connection pins 21. The species of the control IC 22 is corresponding to that of the connectors 13, and the amount of the connection pins 21 is corresponding to that of total terminals in the connectors 13.

Therefore, when connecting to the plurality of connection pins 21 on the motherboard 2 through the connection slot 11, the front line 1 can extend the connectors 13 thereon from the rear end to front end of the computer by using the cable 12, so users can use the connectors more easily.

However, the amount of the plurality of connection pins 21 on the motherboard 2 is corresponding to that of terminals in the connectors 13, so a large arrangement space on the motherboard 2 is needed for setting the plurality of connection pins 21. For example, if the front line 1 has four USB 2.0 connectors thereon, then the motherboard 2 needs to reserve a certain arrangement space for arranging sixteen connection pins 211 because each USB 2.0 connector has four terminals therein. Further, if the connector 13 is an eSATA connector or a USB 3.0 connector, the amount of the plurality of connection pins 21 and the reserved arrangement space will be lager.

As mentioned above, a new expansion module which can extend additional connectors without wasting the arrangement space on the computer motherboard is needed in the market.

### SUMMARY OF THE INVENTION

The present invention is to provide a PCI-E bus achieved connector expansion module for inserting into a PCI-E bus slot on a motherboard of an electronic device, so the electronic device can expand many kind of connectors via PCI-E interface thereon.

The PCI-E bus achieved connector expansion module mentioned above includes a connection joint, a plurality of transmission wires, and at least one connector. Shape and size of the connection joint is corresponding to that of a PCI-E bus slot, so the connection joint can insert into the PCI-E bus slot for electrically connecting with pins in the PCI-E bus which the expansion module connects with. One end of each transmission wires electrically connects to the connection joint separately, and the other end of each transmission wires electrically connect to the connector separately.

In comparing with prior art, the present invention can be used to expand connectors directly via PCI-E bus on the computer motherboard, the motherboard which is connected with needs not to reserve a certain arrangement space for setting the connectors, so the arrangement space on the motherboard can be saved. Further, the expanded connectors can extend to front end of the computer via the transmission wires in the present invention. The expansion module can be used as a front line, so the motherboard needs not to reserve pins thereon for connecting with a front line, the convenience of connectors' usage can be raised.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a connection view of a prior art front line.

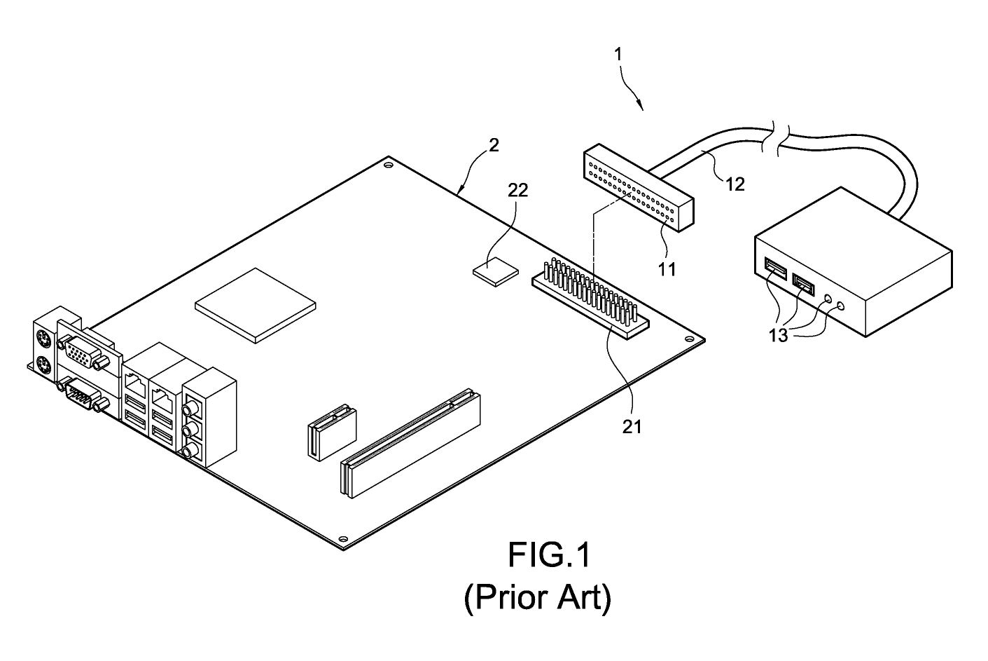

FIG. 2 is a perspective view of a first embodiment according to the present invention.

FIG. 3 is a perspective view of a second embodiment according to the present invention.

FIG. 4 is a perspective view of a third embodiment according to the present invention.

FIG. 5 is a perspective view of a forth embodiment according to the present invention.

FIG. 6 is a perspective view of a fifth embodiment according to the present invention.

FIG. 7 is a perspective view of a sixth embodiment according to the present invention.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

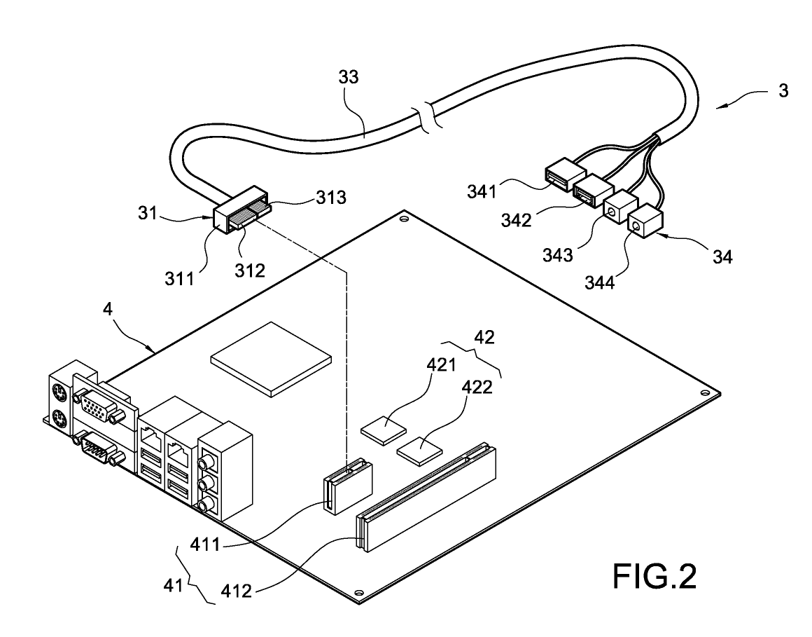

FIG. 2 is a perspective view of a first embodiment according to present invention. A connector expansion module 3 (referred to as the expansion module 3 hereinafter) of the present invention mainly utilized on a motherboard 4 of a computer, the motherboard 4 mainly includes at least one peripheral component interconnect express (PCI-E) bus 41 and at least one control integrated circuit (IC) 42 which is electrically connected to the PCI-E bus 41.

The PCI-E bus 41 mentioned above is a PCI-E x1 bus 411, a PCI-E x16 bus 412, or another species of PCI-E bus (not shown); the control IC 42 is a universal serial bus (USB) control IC 421, external serial advanced technology attachment (eSATA) control IC 422 or an audio control IC (not shown), but not intended to limit the scope of the present invention. In the following descriptions, the PCI-E bus 41 will be illustrated as the PCI-E x1 bus 411.

In the first embodiment of the present invention, the expansion module 3 mainly includes a connection joint 31, a plurality of transmission wires 33, and at least one connector 34. The plurality of transmission wires 33 are coated together with an insulation material, so as to reduce signal interference, and to provide arrangement convenience for user. In FIG. 2, the plurality of transmission wires 33 are illustrated as one thick transmission wire 33.

In this embodiment, the connection joint 31 has a base 311 and a tongue 312 which is extended outward from one end of the base 311, and shape and size of the tongue 312 is corresponding to that of the PCI-E x1 bus 411 slot. The connection joint 31 further includes a plurality of connection terminals 313, which are set in the connection joint 31, and each of the connection terminals 313 protrudes out of the connection joint 31 through the tongue 312 separately.

When the connection joint 31 connecting with the PCI-E x1 bus 411, the tongue 312 of the connection joint 31 inserts into the slot of the PCI-E x1 bus 411, and the plurality of connection terminals 313 are electrically connected to a plurality of pins in the PCI-E x1 bus 411 separately. It should be noted that the extending position of the connection terminals 313 on the tongue 312 is corresponding to the position of the pins in the PCI-E bus 411.

Amount of the transmission wires 33 is corresponding to that of the connection terminals 313, and one end of each of the transmission wires 33 connects to the connection joint 31, therefore, each transmission wire 33 electrically connects to the connection terminals 313 in the connection joint 31 separately. The other end of each of the transmission wires 33 electrically connects to the at least one connector 34.

In this embodiment, the at least one connector 34 is a universal serial bus (USB) connector 341, an eSATA connector 342, or an audio connector (for instance, a headphone output port 343 or a microphone input port 344), but not intended to limit the scope of the present invention. The expansion module 3 connects with the motherboard 4 through the PCI-E x1 bus 411 thereon, so the control IC 42 on motherboard 4 must be connected to the PCI-E x1 bus 411 electrically. For example, if the expansion module 3 has a USB 3.0 connector 341 thereon, the motherboard 4 which connects with the expansion module 3 needs to arrange a USB 3.0 control IC 421 thereon, and the USB 3.0 control IC 421 must be connected to the PCI-E x1 bus 411 on the motherboard 4 electrically.

Further, if the expansion module 3 has a headphone output port 343 and a microphone input port 344 thereon, the motherboard 4 needs to arrange an audio control IC (not shown), and the audio control IC must be connected to the PCI-E x1 bus 411 on the motherboard 4 electrically. Therefore, the motherboard 4 can support the usage of the expansion module 3.

In particularly, the amount of the transmission wires 33 and the connection terminals 313 of this embodiment are corresponding to that of the total terminals on the connectors 34. For example, if the connector 34 is a USB 2.0 connector, which has four terminals therein, then the USB 2.0 connector electrically connects to four transmission wires 33, and electrically connects to four connection terminals 313 through the four transmission wires 33.

For another example, if the connector 34 is a USB 3.0 connector, which has nine terminals therein, then the USB 3.0 connector electrically connects to nine connection terminals 313 through nine transmission wires 33. Thus, if the expansion module 3 has a USB 3.0 connector, an eSATA connector (which has seven terminals therein), and two USB 2.0 connectors thereon, the amount of the transmission wires 33 and the connection terminals 313 must be twenty-four.

It should be noted that the PCI-E x1 bus 411 mainly includes thirty-six pins at most, so the amount of the connection terminals 313 in the connection joint 31 can be thirty-six at most. Further, the amount of the plurality of transmission wires is corresponding to that of the connection terminals 313, which can be thirty-six at most, too.

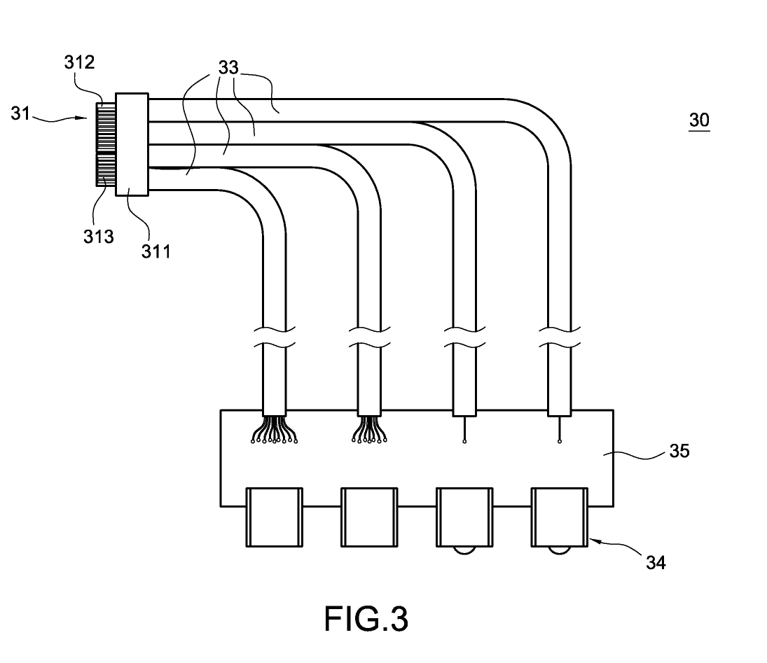

FIG. 3 is a perspective view of a second embodiment according to the present invention. The second embodiment of the present invention discloses an expansion module 30, the expansion module 30 has the same connection joint 31, the plurality of transmission wires 33, and the at least one connector 34 included in the expansion module 3 described above. Furthermore, the expansion module 30 includes a circuit board 35 not shown in the expansion module 3.

One end of the circuit board 35 connects with the other end of the plurality of transmission wires 33, and the other end of the circuit board 35 which is away from the transmission wires 33 connects with the at least one connector 34. The circuit board 35 of the expansion module 30 makes the connection between the plurality of transmission wires 33 and the at least one connector 34 easier, and the circuit board 35 also makes more stable arrangement of the expansion module 30 on a computer.

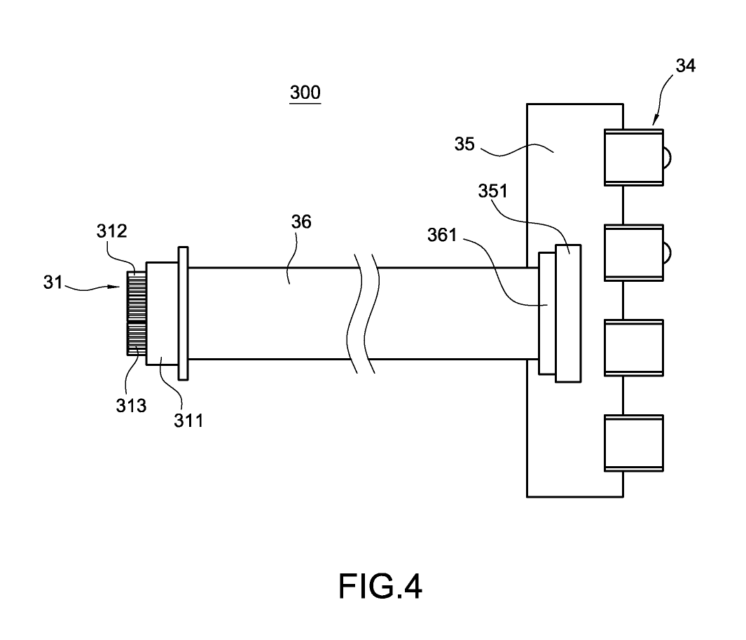

FIG. 4 is a perspective view of a third embodiment according to the present invention. The third embodiment discloses another expansion module 300, the expansion module 300 has the same connection joint 31, the at least one connector 34, and the circuit board 35 included in the expansion module 30 described above. Furthermore, the expansion module 300 replaces the plurality of transmission wires 33 with a cable 36. In particularly, the cable 36 of the expansion module 300 is a flexible flat cable (FFC), but not intended to limit the scope of the present invention.

A connection piece 361 is set on one end of the cable 36, and the other end of the cable 36 connects to the connection joint 31, therefore, the cable 36 electrically connects to the plurality of connection terminals 313 in the connection joint 31. A connection part 351 is set on one end of the circuit board 35, and the circuit board 35 electrically connects to the cable 36 through the connection part 351 and the connection piece 361. The at least one connector 34 electrically connects to the other end of the circuit board 35 which is away from the connection part 351, and the connector 34 electrically connects to the cable 36 through the circuit board 35.

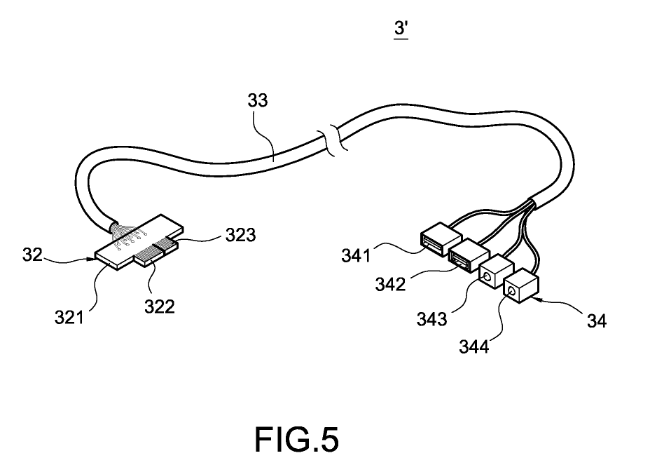

FIG. 5 is a perspective view of a forth embodiment according to the present invention. The forth embodiment discloses another expansion module 3′, the expansion module 3′ has the same plurality of transmission wires 33 and the at least one connector 34 included in the expansion module 3 described above. Furthermore, the expansion module 3′ in this embodiment replaces the connection joint 31in the expansion module 3 with a first circuit board 32.

The first circuit board 32 has a welding part 321 and a protruding part 322 which is protruded from the welding part 321. The shape and the size of the protruding part 322 are corresponding to that of the PCI-E x1 bus 411 slot, and the first circuit board 32 configures a plurality of golden fingers 323 on the protruding part 322. When the expansion module 3′ connects with the PCI-E x1 bus 411, the protruding part 322 of the first circuit board 32 inserts into the slot of the PCI-E x1 bus 411, therefore, the plurality of golden fingers 323 on the protruding part 322 electrically connect with the plurality of pins of the PCI-E x1 bus 411 separately. In particularly, the position of the plurality of golden fingers 323 on the protruding part 322 is corresponding to the position of the pins in the PCI-E x1 bus 411.

The amount of the plurality of transmission wires 33 is corresponding to that of the plurality of golden fingers 323, and one end of each transmission wire 33 is welded to the welding part 321 of the first circuit board 32, so as to electrically connect to the golden fingers 323. The at least one connector 34 electrically connects to other end of the plurality of transmission wires 33.

In particularly, the amount of the plurality of transmission wires 33 and the plurality of golden fingers 323 are corresponding to that of total terminals of the connector 34. For example, if the connector 34 is a USB 2.0 connector, which includes four terminals therein, in this case, the USB 2.0 connector electrically connects to four transmission wires 33, and electrically connects to four golden fingers 323 separately through the four transmission wires 33.

The PCI-E x1 bus 411 mainly includes thirty-six pins, so the amount of the plurality of golden fingers 323 can be thirty-six at most, in particularly, eighteen golden fingers 323 are set on one side of the protruding part 322, and another eighteen golden fingers 323 are set on the other side of the protruding part 322. Further, the amount of the plurality of transmission wires 33 is corresponding to that of the plurality of golden fingers 323, which can be thirty-six at most, too.

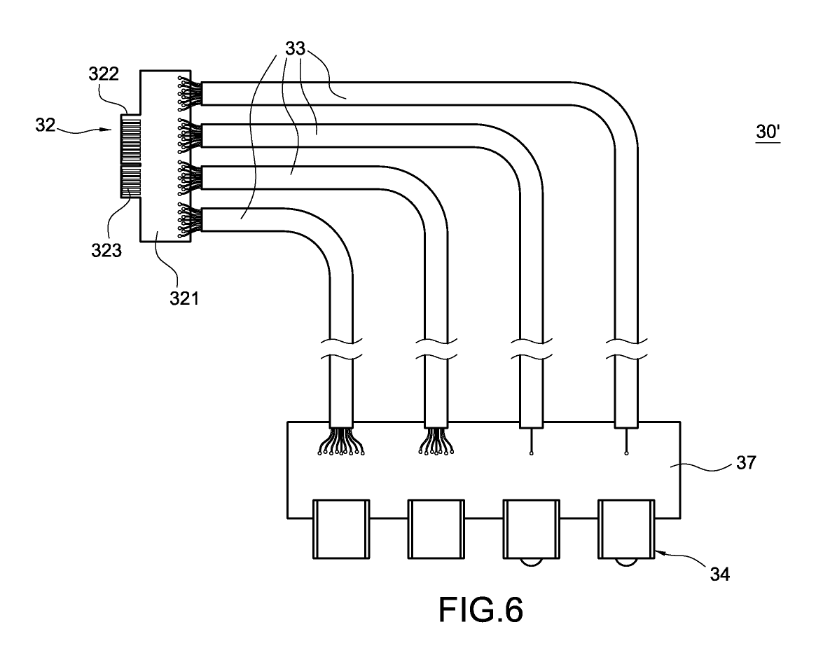

FIG. 6 is a perspective view of a fifth embodiment according to the present invention. An expansion module 30′ is disclosed in this embodiment, the expansion module 30′ has the same first circuit board 32, the plurality of transmission wires 33, and the at least one connector 34 included in the expansion module 3′ described above, and the expansion module 30′ further includes a second circuit board 37. One end of the second circuit board 37 connects with the other end of the plurality of transmission wires 33, and the connector 34 connects to the other end of the second circuit board 37 which is away from the transmission wires 33. The second circuit board 37 of the expansion module 30′ makes the connection between the plurality of transmission wires 33 and the at least one connector 34 easier, and the second circuit board 37 also makes the arrangement of the expansion module 30′ on a computer more stable.

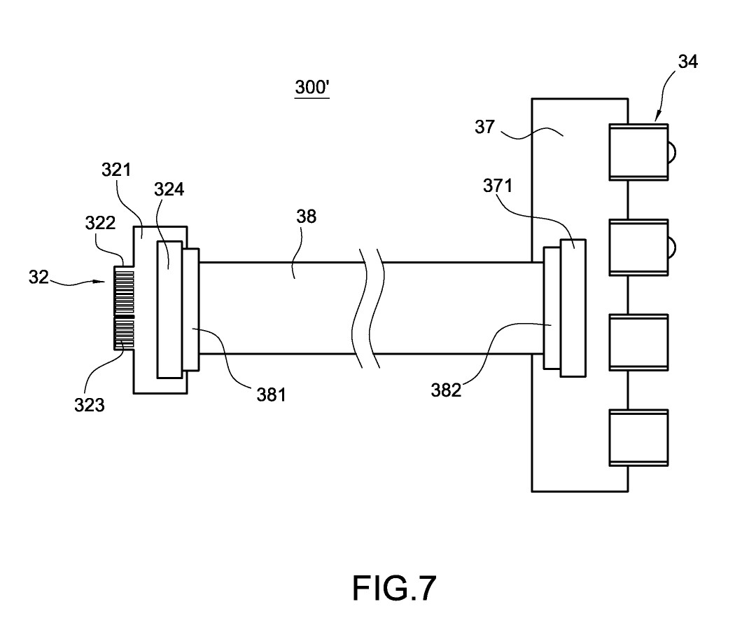

FIG. 7 is a perspective view of a sixth embodiment according to the present invention. An expansion module 300′ is disclosed in this embodiment, the expansion module 300′ has the same first circuit board 32, the at least one connector 34, and the second circuit board 37 in the expansion module 30′ described above. Further, the expansion module 300′ replaces the plurality of transmission wires 33 in the expansion module 30′ with a cable 38, and in particularly, the cable 38 is a FFC, but not intended to limit the scope of the present invention.

The cable 38 has a first connection piece 381 at one end, and has a second connection piece 382 at the other end which is away from the first connection piece 381. The first circuit board 32 has a first connection part 324 at the welding part 321, the cable 38 electrically connects to the first circuit board 32 through the first connection piece 381 and the first connection part 324, so as to electrically connects to the plurality of golden fingers 323 on the protruding part 322 of the first circuit board 32. The second circuit board 37 has a second connection part 371 at one end, and the second circuit board 37 electrically connects with the cable 38 through the second connection part 371 and the second connection piece 382 of the cable 38. The at least one connector 34 electrically connects to the other end of the second circuit board 37 which is away from the second connection part 371, therefore, the connector 34 electrically connects to the cable 38 through the second circuit board 37.

Although the present invention has been described with reference to the foregoing preferred embodiments, it will be understood that the invention is not limited to the description thereof. Any equivalent variations and modifications can be made to those skilled in the art in view of the teaching of the present invention are also in the scope of the invention as defined in the appended claims.

What is claimed is:

1. A PCI-E bus achieved connector expansion module for connecting to a peripheral component interconnect express (PCI-E) bus slot on a computer motherboard, the motherboard having at least one control integrated circuit (IC) for controlling a connector, the control IC electrically connected to the PCI-E bus, and the connector expansion module comprising:
a connection joint having a base and a tongue extending outward from the base, and shape and size of the tongue being corresponding to that of the PCI-E bus slot;
a plurality of connection terminals setting in the connection joint and extending out of the connection joint through the tongue, and the position of the connection terminals on the tongue being corresponding to that of pins in the PCI-E bus slot;
a plurality of transmission wires electrically connected to the connection joint on one end, and electrically connected to the connection terminals in the connection joint separately; and
at least one connector electrically connected to other end of the transmission wires;
wherein, amount of the connection terminals and the transmission wires are corresponding to that of total terminals in the connector, and the tongue is placed in the PCI-E bus slot and the connection terminals are electrically connected to a plurality of pins in the PCI-E bus slot when the connection joint connecting with the PCI-E bus.

2. The connector expansion module according to claim 1, wherein the at least one connector is selected from a group consisting of universal serial bus (USB) 2.0 connector, USB 3.0 connector, external serial advanced technology attachment (eSATA) connector, headphone output port, and microphone input port.

3. The connector expansion module according to claim 1, wherein the amount of the transmission wires and the connection terminals are thirty-six at most.

4. The connector expansion module according to claim 1, further includes a circuit board, on end of the circuit board electrically connects to other end of the transmission wires, and the at least one connector electrically connects to other end of the circuit board which is away from the transmission wires, and the transmission wires electrically connect to the at least one connector through the circuit board.

5. The connector expansion module according to claim 4, wherein the at least one connector is selected from a group consisting of USB 2.0 connector, USB 3.0 connector, external serial advanced technology attachment (eSATA) connector, headphone output port, and microphone input port.

6. The connector expansion module according to claim 4, wherein the amount of the transmission wires and the connection terminals are thirty-six at most.

7. A PCI-E bus achieved connector expansion module for connecting to a PCI-E bus slot on a computer motherboard, the motherboard having at least one control IC for controlling a connector, the control IC electrically connected to the PCI-E bus, and the connector expansion module comprising:
a connection joint having a base and a tongue extending outward from the base, and shape and size of the tongue being corresponding to that of the PCI-E bus slot;
a plurality of connection terminals setting in the connection joint and extending out of the connection joint through the tongue, and the position of the connection terminals on the tongue being corresponding to that of pins in the PCI-E bus slot;
a cable having a connection piece on one end, the cable connected to the connection joint by other end, and electrically connected to the connection terminals in the connection joint;
a circuit board having a connection part at one end, the circuit board electrically connected with the cable through the connection part and the connection piece on the cable; and
at least one connector electrically connected to other end of the circuit board which being away from the connection part, and electrically connected to the cable through the circuit board;
wherein, amount of the connection terminals is corresponding to that of total terminals of the connector, and the tongue is placed in the PCI-E bus slot and the connection terminals are electrically connected to a plurality of pins in the PCI-E bus slot when the connection joint connecting to the PCI-E bus.

8. The connector expansion module according to claim 7, wherein the cable is a flexible flat cable (FFC).

9. The connector expansion module according to claim 7, wherein the at least one connector is selected from a group consisting of USB 2.0 connector, USB 3.0 connector, external serial advanced technology attachment (eSATA) connector, headphone output port, and microphone input port.

10. The connector expansion module according to claim 7, wherein the amount of the connection terminals is thirty-six at most.

11. A PCI-E bus achieved connector expansion module for connecting to a peripheral component interconnect express (PCI-E) bus slot on a computer motherboard, the motherboard having at least one control integrated circuit (IC) for controlling a connector, the control IC electrically connected to the PCI-E bus, and the connector expansion module comprising:
a first circuit board having a welding part and a protruding part protruding from the welding part, shape and size of the protruding part being corresponding to that of the PCI-E bus slot and a plurality of golden fingers configuring on the protruding part, wherein the position of the golden fingers on the protruding part being corresponding to that of pins in the PCI-E bus slot;
a plurality of transmission wires welded to the welding part on one end separately for electrically connecting with the golden fingers; and
at least one connector electrically connected to other end of the transmission wires;
wherein, amount of the golden fingers and the transmission wires are corresponding to that of total terminals in the connector, and the protruding part is placed in the PCI-E bus slot and the golden fingers are electrically connected to a plurality of pins in the PCI-E bus slot when the first circuit board connecting with the PCI-E bus.

12. The connector expansion module according to claim 11, wherein the at least one connector is selected from a group consisting of universal serial bus (USB) 2.0 connector, USB 3.0 connector, external serial advanced technology attachment (eSATA) connector, headphone output port, and microphone input port.

13. The connector expansion module according to claim 11, wherein the amount of the transmission wires and the golden fingers are thirty-six at most.

14. The connector expansion module according to claim 11, further includes a second circuit board, on end of the second circuit board electrically connects to other end of the transmission wires, and the at least one connector electrically connects to other end of the second circuit board which is away from the transmission wires, and the transmission wires electrically connect to the at least one connector through the second circuit board.

15. The connector expansion module according to claim 14, wherein the at least one connector is selected from a group consisting of USB 2.0 connector, USB 3.0 connector, external serial advanced technology attachment (eSATA) connector, headphone output port, and microphone input port.

16. The connector expansion module according to claim 14, wherein the amount of the transmission wires and the golden fingers are thirty-six at most.
